(19) United States
(12) Patent Application Publication
(10) Pub. No.: US 2017/0211841 A1
(43) Pub. Date: Jul. 27, 2017

(54) Flip hinged filter grille on service panel cover for air conditioning fan coil

(71) Applicant: Joe Adamian, SR., Glendale, CA (US)

(72) Inventor: Joe Adamian, SR., Glendale, CA (US)

(21) Appl. No.: 15/005,804

(22) Filed: Jan. 25, 2016

(51) Int. Cl. F24F 13/08; B01D 46/00; F24F 13/28

(52) U.S. Cl. CPC F24F 13/085; F24F 13/084; F24F 13/28; B01D 46/0005; B01D 46/0039; B01D 2265/027; B01D 2279/40

(57) ABSTRACT

A method and apparatus for allowing easy access to air conditioning/heating/ventilation through a panel that has flip hinges connecting the filter grill to the panel. Traditional “Filter Grill Panels” require removal from the air conditioning vent when replacing a filter or accessing the vent. The inventor has created a “Filter Grill Panel” with two flip hinges which allow for the panel to stay connected to the vent and not require complete removal of the panel. The “Flip Hinged Filter Grill” will save time whenever access to the air conditioning vent is needed and allows for easier opening and closing of the Filter Grill Panel which otherwise is completely removed in order to replace or install an air filter by unscrewing multiple screws and removal of the panel. Reference numbers 100—Vent Panel 44×30 inch (Plan view and Axonometric view); 101—Filter Grill 26×12 inch (Plan view and Axonometric view); 102—Hinge 1¼ inch (Plan view and Axonometric view); 103—Clip Lock 2 inch (Plan view and Axonometric view).

### TECHNICAL FIELD

The present disclosure relates to heating, ventilation, and air conditioning and more particularly, to the access panel grill used to remove and replace air filters.

### BACKGROUND

An access door panel to allow for the installation, replacement, or removal of air conditioning filters is commonly found in residential or commercial structures which have heating, ventilation, and air conditioning shafts and vents.

Filter grills are located on the panel and are removed from the panel for access to allow the air conditioning filter by screws and bolts.

Unfortunately, in conventional systems, the removal of screws and bolts in order to remove the filter grill to provide access to the panel and replace or install an air conditioning filter is cumbersome and inefficient.

### SUMMARY OF THE DISCLOSURE

The embodiment provides a method which does not require removal of the filter grill by screws and bolts where the filter grill itself remains hinged to the panel while still allowing access to the area behind the filter grill for installation, replacement, or removal of an air conditioning filter.

The embodiment provides a method by a flip hinge and a clip, specifically a two flip hinged access door that opens without screws or bolts and which also remains connected by the hinges when opened for easier access in opening and closing the filter grill which provides access to the area for installation of an air conditioning filter.

### BRIEF DESCRIPTION OF THE DRAWINGS

So that the manner in which the above recited features of the present disclosure can be understood in detail, a more particular description of the disclosure briefly summarized above, may be had by reference to embodiments which are illustrated in the appended drawings.

FIG. 1 illustrates a diagram as an example of a service panel (Ref. #100) for a heating, ventilation, and air conditioning filter, 44×30 inches, along with the filter grill (Ref. # 101), hinge (Ref. #102), and clip lock (Ref. #103) in accordance with certain embodiments of the present disclosure in plan and axonometric views.

### DETAILED DESCRIPTION

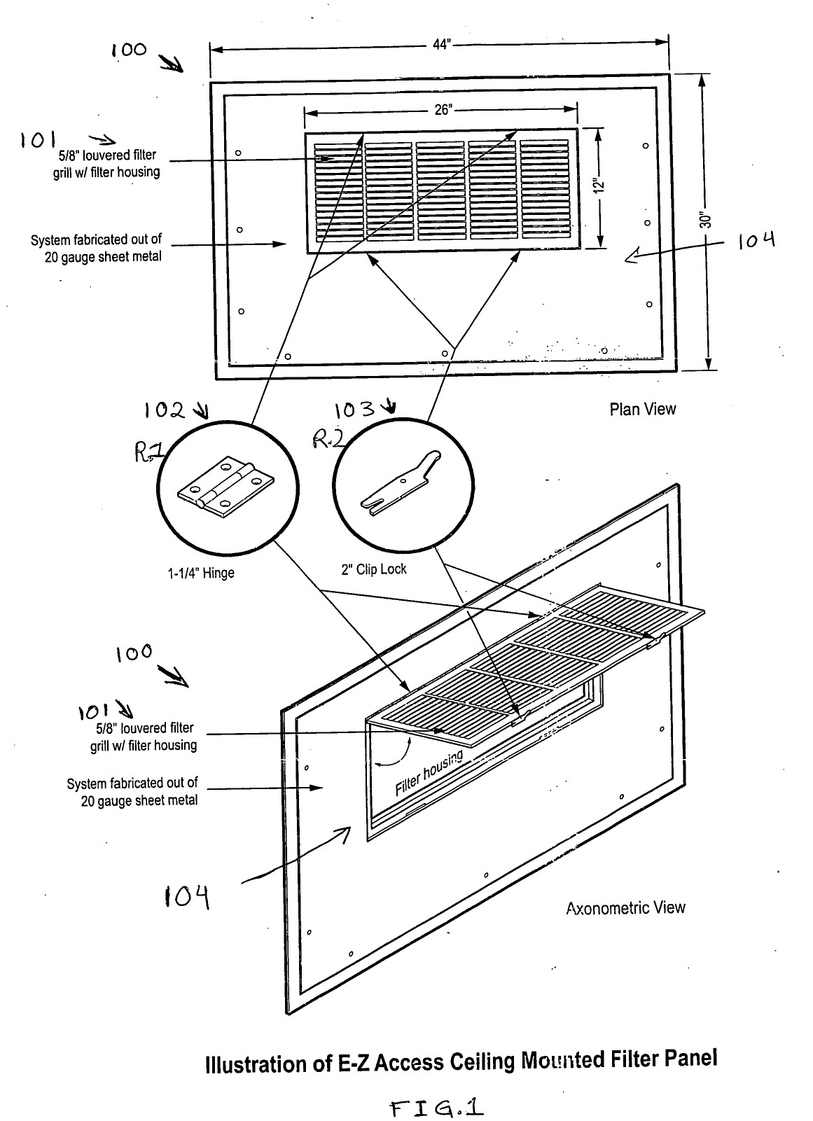

FIG. 1 Ref. #100 illustrates an example of a service panel for a heating, ventilation, and air conditioning filter, 44×30 inches, in accordance with certain embodiments of the present disclosure in plan and axonometric views.

FIG. 1 Ref. #101 illustrates an example of the method of the present disclosure where the filter grill which is attached to the service panel (FIG. 100) operates by opening and closing by a hinges (Ref. #102, 103) for access to allow for installing, replacement, or removing a heating, ventilation, and air conditioning filter, 44×30 inches, in accordance with certain embodiments of the present disclosure in plan and axonometric views.

FIG. 1 Ref. #102 illustrates an example of the hinges, 1¼ inches in size which are affixed to the filter grill (Ref. #101) and service panel (Ref. #100) in accordance with embodiments of the present disclosure.

FIG. 1 Ref. #103 illustrates an example of the clip locks, 2 inches in size, which are affixed to the filter grill (Ref. #101) and service panel (Ref. #100) in accordance with embodiments of the present disclosure.

FIG. 1 Ref. #104 illustrates an example of the filter housing which is where the heating, ventilation, or air conditioning filter is installed, replaced, or removed as demonstrated by the plan and more clearly seen in the axonometric view in accordance with embodiments of the present disclosure.

### Flip Hinged Filter Grill for Heating, Ventilation, Air Conditioning Service Panel

The method and apparatus of the present disclosure may be utilized in a heating, ventilation, air conditioning service panel. It allows for the filter grill to be opened and closed without complete removal from the service panel providing access to the filter area where the heating, ventilation, and air conditioning filter is installed, replaced, or removed.

What is claimed is:

1. A method for opening and closing the filter grill on a heating, ventilation, air conditioning service panel to allow for access to the filter housing where the heating, ventilation, air conditioning filter is installed without requiring the complete removal of the grill.

2. The method of claim 1, wherein the filter grill panel opens and closes without complete removal by the use of hinges and clip locks.

3. The method of claim 1, where the clip lock is rotated which allows the filter grill to open and close without being completely removed.

4. The apparatus of claim 1, where the filter grill is hinged to the service panel by hinges at the top of the filter grill panel and the filter grill remains connected to the service panel as it opens and closes to allow access to the filter housing area where the heating, ventilation, air conditioning filter is installed, replaced, or removed.
